(19) United States
(12) Patent Application Publication
(10) Pub. No.: US 2015/0230625 A1
(43) Pub. Date: Aug. 20, 2015

(54) FACILITY FOR REFRESHING ITEMS DISPLAYED FOR SALE WITH A MIST OF WATER DROPLETS

(71) Applicant: Areco Finances et Technologie - Arfitec, Grasse (FR)

(72) Inventors: Michel Gschwind, Placassier (FR); Fabien Fages, Monaco (FR); Julien Dubois, Mouans-Sartoux (FR)

(21) Appl. No.: 14/420,473

(22) PCT Filed: Aug. 6, 2013
(86) PCT No.: PCT/FR2013/051889

§ 371 Date: Feb. 9, 2015

(30) Foreign Application Priority Data
Aug. 9, 2012 (FR) 1202220

(51) Int. Cl. A47F 3/00; B05B 15/04

(52) U.S. Cl. CPC A47F 3/001; B05B 15/0406

(57) ABSTRACT

A facility for diffusing a mist of water droplets on products, in particular, on food products displayed for sale, for the purposes of moistening or cooling them. The facility includes at least one area for receiving products, a generator of mist droplets, at least one diffuser of mist droplets to spray a mist over the area for receiving products, at least one suction mechanism and at least one suction port arranged in the surface of the area for receiving products. The suction mechanism is to suck at least one portion of the mist sprayed over the area for receiving products through the at least one suction port.

### CROSS-REFERENCE TO RELATED APPLICATIONS

The present application is a National Stage Application of PCT International Application No. PCT/FR2013/051889 (filed on Aug. 6, 2013), under 35 U.S.C. §371, which claims priority to French Patent Application No. 12 02220 (filed on Aug. 9, 2012), which are each hereby incorporated by reference in their respective entireties.

### TECHNICAL FIELD

The invention relates to facilities for diffusing a mist of water droplets on products, in particular, on food products displayed for sale, for the purposes of moistening or cooling them.

### BACKGROUND

Shelves for displaying food products used in places of sale and which comprise diffusers that spray a mist of water droplets over the area of shelving receiving the products are known, for example in document FR 2 921 551. Such a facility preserves the freshness of the products, improves their appearance in the display case and encourages the sale of them.

However, according to the location where the piece of furniture is installed, it is sometimes observed that the flow of mist is sensitive to the air currents, to the extent that it is necessary to increase the flow rate of the mist and/or its speed in order to obtain the desired effect which increases the consumption of water and energy. In other cases, it occurs that the mist, or at least a portion of the latter, falls outside of the piece of furniture rather than on the products, which can be for example fruits or vegetables. This is not desirable, for several reasons: it decreases the effectiveness of the cooling of the facility, the mist sprayed as such can be sucked in by refrigerated devices located in the vicinity of the facility, and this can be perceived by the customers of the sales outlet as unattractive or threatening.

Finally, it is sometimes difficult to obtain a homogeneous diffusion of the mist in such a way that certain products receive many more droplets than others.

### SUMMARY

A purpose of the invention is to improve the facilities for diffusing a mist of droplets. Another purpose of the invention is to better confine the mist on the products displayed for sale. Another purpose of the invention is to improve the cooling of the products. Yet another purpose of the invention is to decrease the consumption of energy and of water of such a facility for diffusing a mist of water droplets.

These purposes are achieved by a facility, such as a piece of furniture, for presenting products (in particular products of vegetable or animal origin and/or sensitive to drying out) for sale, comprising at least one area for receiving products, a generator of mist droplets and at least one diffuser of mist droplets capable of spraying mist over said area for receiving products in order to refresh, moisten and/or cool said products, said facility being characterized in that it further comprises at least one suction means and at least one suction port arranged in the surface of said area for receiving products, or in the vicinity of said surface, said suction means being able to suck at least a portion of the mist sprayed over said area for receiving products through said at least one suction port. Said area for receiving products can be mounted on a caisson with which communicate said suction ports arranged in the surface of said area for receiving products, or in the vicinity of said surface, and which can be underpressurized by said suction means, in such a way that during the operation of the facility, said mist is sucked into said caisson by said suction means through said suction ports. Said caisson can comprise a product storage area, and more preferably at least one sliding drawer able to receive products. Said caisson can also comprise a ventilation fan. Said generator of mist droplets generally comprises a piezoelectric element operating at an ultrasound frequency, and can comprise either an ultrasound concentration nozzle or a micro-perforated membrane.

In an embodiment, the facility comprises diffusers of droplets that can direct the mist towards said area, with said diffusers being arranged more preferably at the periphery of said area for receiving products. It can, alternatively or in addition, comprise diffusers of droplets able to direct the mist in the direction opposite the area. In particular, it can comprise at least one first diffuser able to direct the mist in the direction of the area for receiving products, and at least one second diffuser able to direct the mist in the direction opposite the area, arranged in such a way that said area extends between said first and said second diffusers. In an alternative, the second diffuser extends at a height less than that of the first diffuser. The facility can include at least one diffuser, or a group of diffusers located on a band of the facility.

According to an advantageous and general embodiment, the facility according to the invention comprises a plurality of diffusers arranged in staggered fashion. These diffusers arranged staggered fashion can represent all of the diffusers of the facility, or only one or several groups of diffusers of the facility.

Another object of the invention is a method for refreshing, moistening and/or cooling products of vegetable or animal origin presented for sale and placed on the surface of an area for receiving a facility according to the invention, comprising: the diffusion of a mist of droplets over the products, and the suction of said mist of droplets through at least one suction port arranged in said surface or close to this surface.

The invention shall now be described in greater detail.

According to the invention a facility is provided, such as a piece of furniture, which comprises at least one area for receiving products (also called shelving area or area for presenting products), at least one diffuser of a mist of droplets capable of spraying a mist of droplets over the area for receiving products, and a suction of the mist of droplets through slots or ports located on the area for receiving products, or in the vicinity of the latter. Advantageously at least a portion of said slots or of said ports is located at the periphery of the area for receiving products and/or on the bottom of said area for receiving. As such, the mist of droplets (also called atomization) spreads out over the products displayed for sale in order to moisten, refresh and cool them, the atomization covers and envelops the products and as such can spread out between the individual products, and is sucked on the sides of the shelving area and/or through the bottom of the area for receiving in a space located under the area for receiving products. Said space can be a caisson.

The suction can be carried out by any suitable means, for example by at least one fan which is typically arranged under the area for receiving products. In a particular embodiment, the atomization is sucked into a caisson located in the bottom of said facility, i.e. under the area for receiving products, said caisson comprising a suction means which can underpressurize it, for example at least one fan.

In an advantageous embodiment of the invention, the space located under the area for receiving products, which can be a caisson, is arranged as a product storage area. The suction of the mist of droplets by the at least one diffuser through said slots and/or ports in the caisson not only makes it possible to better moisten, refresh and cool the products that are on the area for receiving products, but it further makes it possible to moisten, refresh and cool a stock of products that are not displayed for sale which is located in said product storage area. This product storage area can be used for intermediate storage: the personnel of the point of sale can stock in case of need the area for receiving products with fresh products by removing the latter from said storage area, without having to go to a storage area far from the point of sale. In addition, the products that are not displayed for sale that are in the product storage area re-stocked as such are in an impeccable state of freshness. The storage area can comprise one or several diffusers of mist and/or at least one fan for ventilating the air which provides a good distribution of the mist within this storage area.

Generally, the mist sucked in the space located under the at least one area for receiving, this space able to be a caisson, is then ejected outside of this space after having made it possible to cool the stall and the caisson. In a particular embodiment, this flow of cold fluid can be directly re-injected to the inlet of the fan which supplies the droplet generator so that the latter, by sucking a colder and more moist air, has a better energy output and decreased consumption of water. For this, it is necessary for the air sucked by the droplet generator to be taken at least partially in the atmosphere of the caisson, knowing that the air of the caisson comes in part from the mist sucked in the vicinity of the area for receiving products.

Generally, the mist of droplets comprises a majority of fine droplets, i.e. of an average size less than 10 μm, more preferably between 0.5 μm and 10 μm, and encore plus preferentially between 0.5 μm and 5 μm. More precisely, according to the invention it is preferred that about 95% of the droplets have a diameter between 1 μm and 5 μm, more preferably between 1 μm and 4 μm, and most preferentially between 2 pm and 3 μm.

A mist comprised of so fine droplets forms a patch of mist that floats over the area for receiving and products displayed for sale. In the absence of external currents of air it slowly descends and spreads out widthwise: as such it envelops the products displayed for sale, which is desirable, but it can overflow off of the piece of furniture, which is not desirable.

Such a mist of fine droplets can be generated by a droplet generator, for example of the type comprising one or several ultrasound piezoelectric emitters provided for example with a sound concentration nozzle used for the production of the mist formed by the droplets of water in suspension in an air flow. Such generators are known as such, for example documents FR 2 788 706, EP 0 782 885 or EP 0 782 885. The frequency of the piezoelectric emitter is advantageously between 1 MHz and 3 MHz, and preferentially between 1 MHz and 2.5 MHz.

Another type of droplet generator that can be used in the framework of this invention comprises a piezoelectric element which vibrates the body of a rigid piezoelectric transducer comprising a cavity intended to contain a liquid to be atomized, said cavity being covered by a micro-perforated membrane which is set into vibration by the piezoelectric element in “piston” mode; such a device is described in document WO 2008/058941. A frequency generated by the piezoelectric element between 40 kHz and 200 kHz is suitable. The mesh of the micro-perforated membrane is advantageously between 2 μm and 40 μm.

For both types of generators, the increase in the frequency results in a decrease in the size of the droplets, but also in an increase in the energy consumption of the generator.

The droplet generator can be arranged under the area for receiving products, inside or outside the caisson. The mist of droplets is conveyed by at least one duct of the generator to at least one diffuser of mist, and sprayed on the at least one area for receiving products.

The area for receiving products shall now be described in more detail, and then the diffuser of mist. The area for receiving products has a surface on which the products are typically placed; this surface can be flat, and in this case it can be horizontal or inclined, or it can be curved or comprise curved segments, or it can be of any other suitable shape. The choice of the geometrical shape of this surface can depend on the nature of the products. This surface can be made from any suitable material, in particular from any material that is easy to clean (for example metal (preferably stainless steel) or plastic). The area for receiving products can be delimited by bands and/or by walls, which can be of any suitable shape and for example vertical, inclines, curved. The area for receiving products can be subdivided by fixed or movable walls in order to allow for the separation of products of a different nature. A facility according to the invention can have several areas for receiving products, which can for example be arranged as a staircase, or entirely or partially superimposed, or side by side.

According to the invention, the zone for receiving comprises ports or slots through which the mist can be sucked in the caisson located underneath. These ports or slots can have any useful shape. They can be arranged for example in the surface of the area for receiving and/or in the band that laterally limits the area for receiving products and/or at the periphery of the surface of the area for receiving products. The surface of the area for receiving can comprise grilles through which the mist is sucked.

Said at least one diffuser capable of spraying a mist of water droplets over the area for receiving products can have different forms. Their number can vary; most often a plurality of diffusers is used, which may be of identical or different shape and function.

Indeed, according to the location where the piece of furniture is installed, it is sometimes observed that the flow of mist is sensitive to the air currents, to the extent that it is necessary to increase the flow rate of the mist and/or its speed in order to obtain the desired effect which increases the consumption of water and energy. In other cases, it is sometimes difficult to obtain a homogeneous diffusion of the mist in such a way that certain products receive many more droplets than others.

With the aim to further improve the facilities for diffusing a mist of droplets, it can be provided within the framework of this invention that the facility, such as a piece of furniture, comprise at least one area for receiving products and diffusers of a mist of droplets over the area, with the diffusers comprising: at least one first diffuser able to direct the mist in the direction of the area, and at least one second diffuser able to direct the mist in the opposite direction of the area, with the latter extending between the first and second diffusers.

As such, according to a particular embodiment of the invention, the first and the second diffuser, or the first and the second diffusers, form conflicting diffusers. Advantageously, these conflicting diffusers are arranged in staggered fashion. The function of the first diffuser is to refresh the products by means of the mist. The function of the second diffuser is in particular to improve the effectiveness of the diffusion carried out by the first diffuser. Indeed, the flow of the second diffuser renders the flow of the first less sensitive to air currents and favors its confinement on the piece of furniture, in the product area. The second diffuser acts somewhat like a curtain of air that protects the mist of the first diffuser with regards to the ambient movements and air currents. A more homogeneous diffusion of the mist over the products is as such obtained. This is the case in particular when the invention is used over shelf heads which constitute a difficult area for atomization. Naturally, the stream of mist of the second diffuser is also used to refresh the products in addition to its function of protection with regards to the first diffusers explained hereinabove. Since in this embodiment the effectiveness of the diffusion is improved, the output of the facility is improved and its consumption of water and of energy are reduced, the quantity of mist used per square meter being less than in known facilities. When the invention is implemented on a place of sale with this embodiment of the diffusers, the second diffuser with its stream of mist also renders the entire shelving and the products for sale even more attractive for the public.

Preferably, the second diffuser is able to direct the mist upwards, in particular with an inclination of 45° with respect to the vertical direction. This characteristic is implemented in particular when the area for receiving products is horizontal or slightly inclined with respect to the horizontal plane.

Preferably, the second diffuser extends at a height less than that of the first diffuser. The mist of the second diffuser then protects even better that of the first. It indeed provides protection over a greater fraction of the height that running in the opposite direction of the mist of the first diffuser from its exiting from the diffuser to the area.

Advantageously, the first diffuser is located at a distance from the periphery of the facility. Preferably, the second diffuser is located at the periphery of the facility. In this way, the second diffuser protects the mist of the first in a particularly effective manner as its mist is emitted at the boundary of the facility with the ambient environment. Advantageously, the second diffuser is located on a band of the facility. As such, the second diffuser is integrated into the facility discreetly and is not bulky.

If the facility has a plurality of areas for receiving products, for example two, it is advantageous that at least one of the diffusers be able to diffuse the mist on the two areas, with each area extending between this diffuser and another of the diffusers. It can be provided, for example, that the facility comprise at least two first diffusers that define a first straight line and at least two second diffusers defining a second straight line parallel to the first straight line. As such, the streams of mist of the second diffusers cooperate in order to form a patch that jointly protects the streams of mist of the first diffusers.

It can also be provided that the facility comprises several second diffusers that form a unit surrounding the first diffuser or diffusers. Here again, the second diffusers cooperate in order to protect the mist emitted by the first diffuser or diffusers.

Advantageously, the first diffuser has at least one port for atomization of elongated shape according to the vertical direction. Such a port makes it possible to produce a stream of mist that has a good angular distribution in the vertical and horizontal planes. Advantageously, the second diffuser has at least one port for atomization of circular shape. Advantageously, the first diffuser is mounted on a mast. The second diffuser can however also be mounted on a mast. It can be provided that certain at least of the first and second diffusers can be oriented and/or entirely or partially obstructed.

A method for diffusing a mist of droplets over products is also provided according to the invention, wherein at least one first diffuser diffuses the mist in the direction of the products and at least one second diffuser diffuses the mist by directing it in the opposite direction of the products, with the products extending between the first and second diffusers.

Preferably, the first diffuser or all of the first diffusers has a mist flow rate greater than that of the second diffuser or of all of the second diffusers. This difference in flow rates does not prevent the aforementioned confinement from being obtained and makes it possible to optimize the consumption of energy and of water.

Preferably, the second diffuser produces a stream of mist that has a higher speed than that of the stream produced by the first diffuser. This difference in speed improves the confinement effect, even in the absence of suction. The confinement of the patch of mist on the products displayed in the area for receiving products, which is reached by this embodiment, is further improved by the suction of the mist of droplets through the slots and/or ports according to the invention: the inventors observe that practically no portion of the mist falls outside the piece of furniture.

Generally, the facility according to the invention can be used for any product that has to be presented with regards to a purchaser, and which has to be able to be apprehended by the purchaser, and which requires moistening, refreshing and/or cooling or which benefits from such a treatment, and in particular for products that are sensitive to drying out. These products can in particular be of vegetable or animal origin. This can be for example food products: fruits, vegetables, meat, fish, cheese, salads, or non-food products such as plants and cut flowers.

### DRAWINGS

Other characteristics and advantages of the invention shall appear in the following description of embodiments of the invention and of alternatives given by way of unrestricted examples in reference to the annexed drawings wherein:

FIGS. 1 and 2 illustrate perspective views of two alternatives of a piece of furniture according to the invention used to present and refresh items displayed for sale.

FIGS. 3, 4 and 5 illustrate plan views respectively of the lateral site, from the top and of the front side of the same piece of furniture, FIG. 5 being a view of the section A-A indicated in FIG. 4.

FIG. 6 illustrates a diagrammatical view of the section C-C indicated in FIG. 5.

FIG. 7 illustrates an enlarged view of an area of FIG. 5 marked by a circle and the letter A.

FIGS. 8 and 9 illustrate perspective views of another piece of furniture according to the invention used to present and refresh items displayed for sale.

FIG. 10 illustrates a plan view of the piece of furniture of FIGS. 8 and 9, without the products.

FIGS. 11 to 14 illustrate diffusers of mist that can be used to carry out a facility according to the invention.

FIG. 15 illustrates a cross-section view of a piece of furniture similar to that of FIG. 8 which shows the operation of the diffusers of mist.

FIG. 16 illustrates a perspective view of the area for receiving with its diffusers of mist of another facility according to the invention.

FIG. 17 illustrates an enlarged view of an area of FIG. 16 with an alternative.

### DESCRIPTION

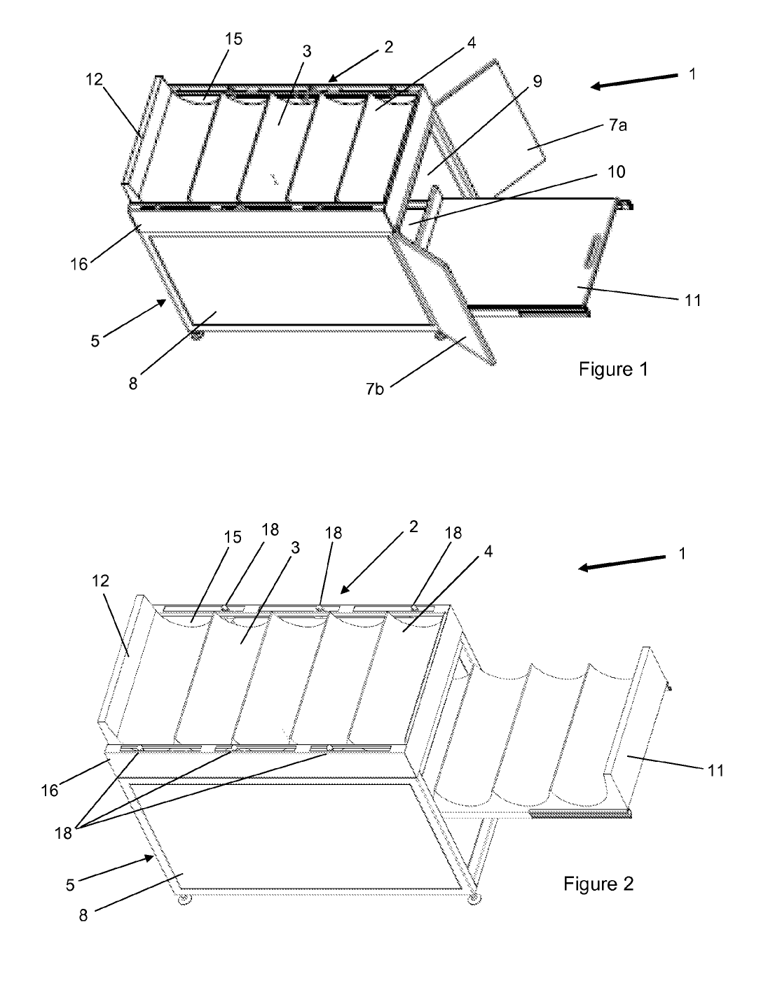

FIGS. 1 to 7 show a facility 1 for presenting food products according to the invention. This here is a piece of furniture forming a table comprising an area 2 for receiving products having a surface 3 comprising curved segments 4. On one of its front sides, the area 2 for receiving products is delimited by a band 12. Under the area 2 for receiving products is the caisson 5, comprising two front walls 6, 7, two side walls 8, 9 and a floor 10.

FIG. 1 shows an embodiment wherein one of the front walls 7, carried out here in the form of two wings 7a, 7b, can be opened in order to access a space for storing products located in the caisson 5. A sliding drawer 11 facilitates access to this storage area. The suction openings 15 are arranged between the side band 16 and the surface 3 of the curved segments 4.

FIG. 2 shows an alternative of the embodiment of FIG. 1, wherein the sliding drawer 11 is not at the bottom of the caisson 5 but rather in the middle; this makes it possible to position electrical components (in particular the droplet generator, not shown in the figure) under the drawer 11; this is shown in FIG. 6. In this alternative, the drawer 11 (or at least its upper portion) and the area 2 for receiving products can be provided to be interchangeable. This allows an employee at the point of sale to replace the empty area 2 for receiving with the drawer 11 garnished with refreshed products and to put it in place of the empty drawer in order to possibly arrange products to be refreshed on its surface. FIG. 2 also shows the position of the nozzles 18 for diffusing the mist.

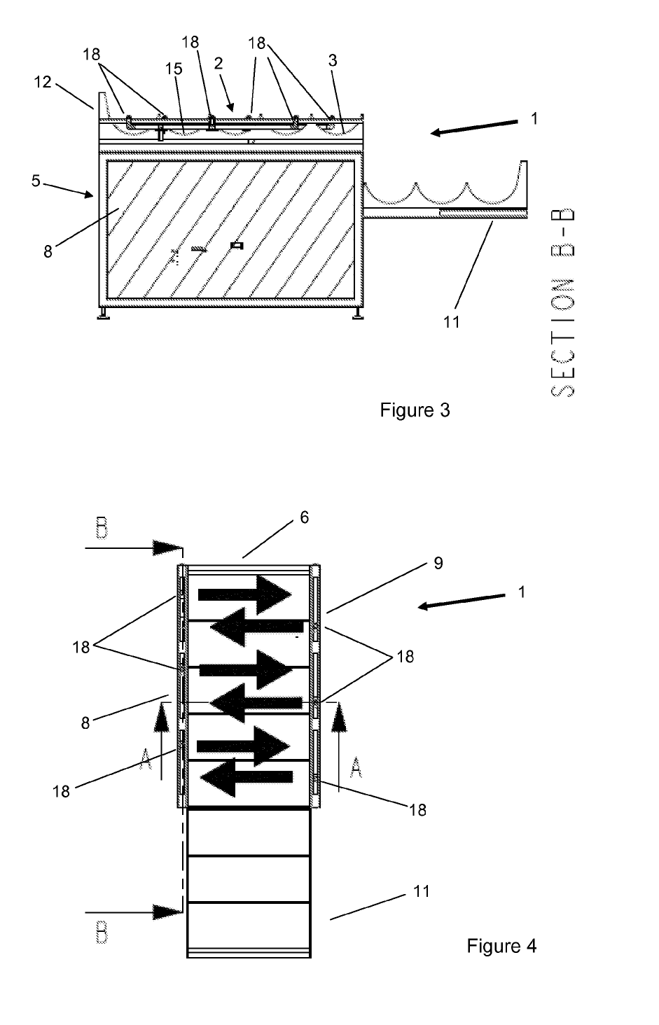

FIG. 3 shows in greater detail the surface of the area 2 for receiving products composed of a plurality of curved segments 4. This figure does not show the side band in order to show the suction openings 15.

In the embodiment shown in FIG. 4, the facility 1 comprises six nozzles 18 for diffusing the mist arranged in staggered fashion. These nozzles 18 blow the mist on the stall of food products, as indicated by the thick arrows.

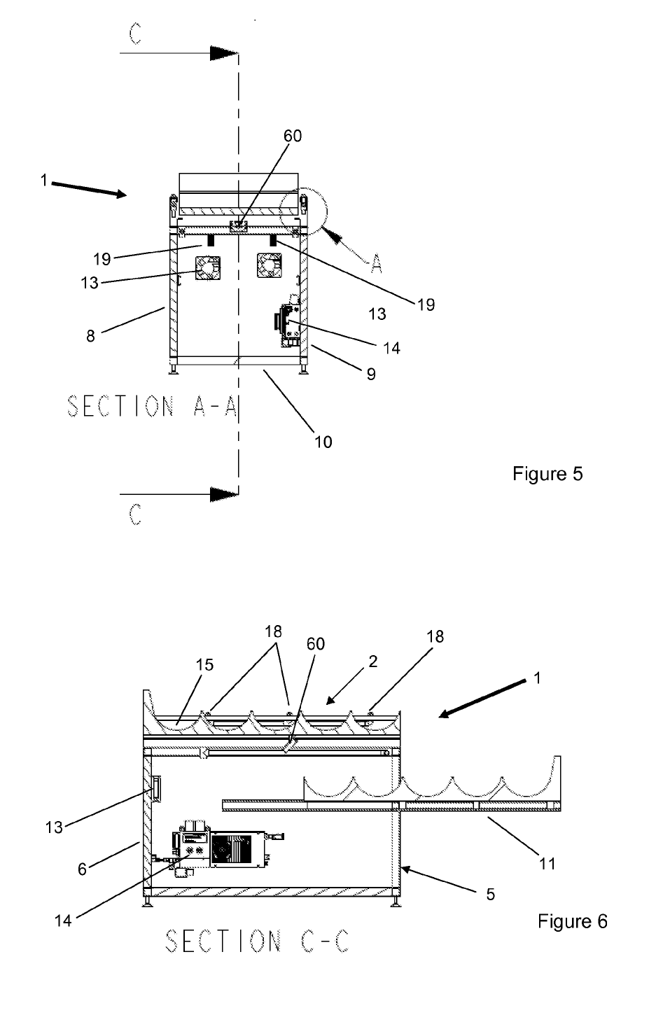

FIG. 5 shows an embodiment with two fans 13 arranged in a front wall 6 of the caisson 5. The droplet generator 14 here is in the caisson 5. In this alternative, two atomization nozzles 19 are in the storage area of the caisson.

FIG. 6 shows the positioning of the fan 13 and of the droplet generator 14 for the alternative of FIG. 2 with the drawer 11 at mid-height of the caisson 5. The mist diffused by the atomization nozzles 18 is sucked from the area 2 for receiving products through the suction openings 15 inside the caisson 5, spreads out on the products arranged on the surface of the drawer 11, then is discharged outside of the caisson 5 through the fan 13.

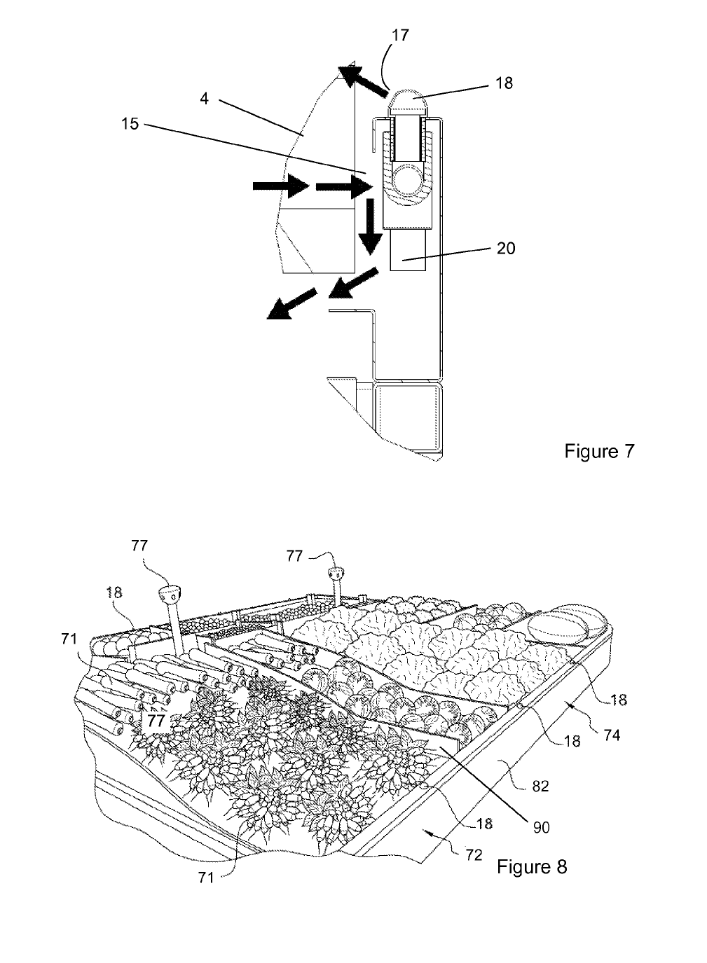

FIG. 7 shows a cross-section view of a nozzle or of a diffuser of mist 18 arranged at the periphery of the area for receiving, with their supply duct 20 which is connected to the droplet generator (not shown in this detailed figure); the thick arrow indicates the direction of output 17 of the mist. The suction opening 15 is also seen; the thick arrows indicate the direction of suction of the mist in the caisson 5.

FIGS. 8 to 15 show another facility 70 according to the invention. Here, this is a piece of furniture forming a table.

As shown in FIG. 8, this piece of furniture is used in a place of sale for presenting vegetable food products. The products here are vegetables 71.

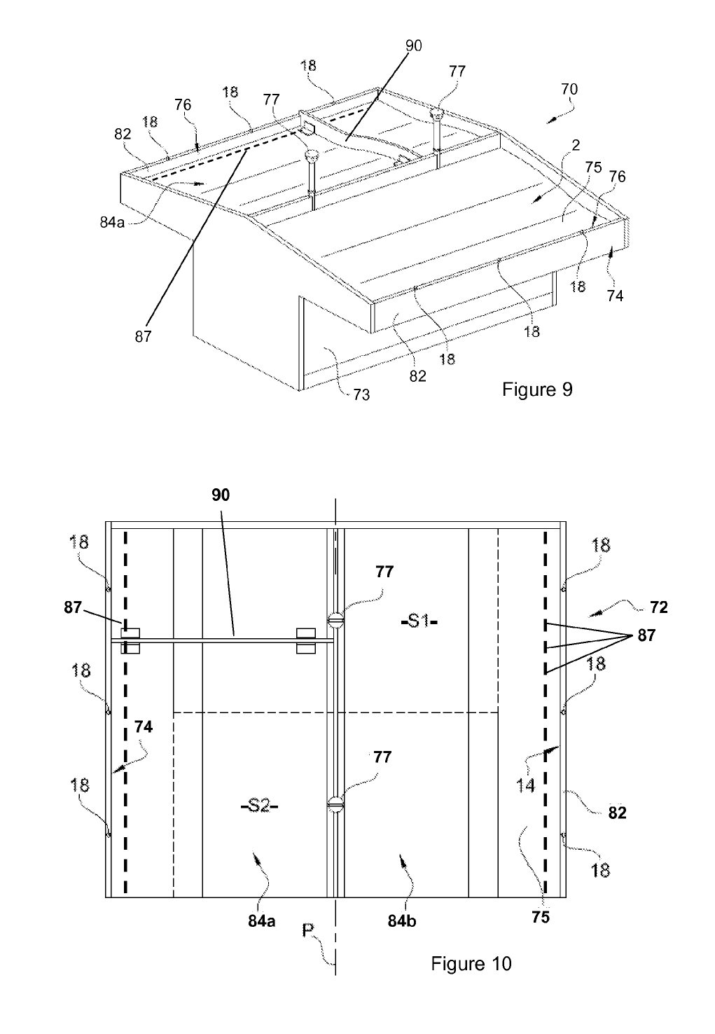

As shown in FIG. 9, the piece of furniture 72, which here forms a display case, comprises in the lower portion a frame 73 forming a leg of the piece of furniture and in the upper portion a shelf 74 resting on the frame 73 and which here has a rectangular shape in plane.

As shown in FIG. 10, the piece of furniture here has a vertical median plane with symmetry P. The shelving 74 represents the area for receiving products and comprises a bottom wall 75 which forms the surface of the area for receiving products, which is here not of planar form but, in its lower portion, substantially horizontal. The bottom wall 75 here has a rippled shape to the extent that its profile passes through a maximum height on plane P, with the end edges 76 of the wall 75 located at a height that is lower than that of its median line. Note in FIG. 10 that the conflicting diffusers (i.e., the first diffusers 77 and the second diffusers 18) are arranged in staggered fashion.

The display case is able to receive products such as vegetables 71. It is open in the upper portion in such a way that the products can be observed or apprehended by the public passing in the vicinity of the display case.

The piece of furniture 72 comprises means for diffusing a mist of atomized water droplets, over the products and until the latter in order to preserve the freshness thereof. For this purpose, the piece of furniture 72 comprises first diffusers 77 and second diffusers 18. The first diffusers 77 here number two. They each extend in the median portion of the display case, at a distance from its periphery, and intercept the plane P. The two first diffusers 77 are identical to one another.

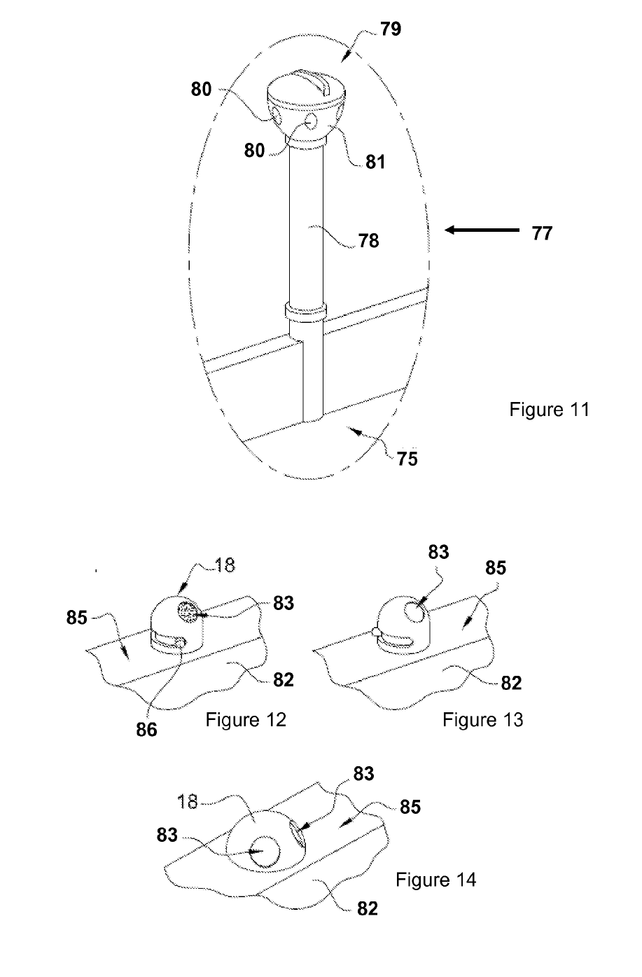

As shown in FIG. 11, first diffusers 77 each include a cylindrical rectilinear vertical mast 78 with a circular transversal section. They also include a head 79 extending at the upper end of the mast. The head is entirely closed except for the atomization ports 80 which here have an elongated shape according to the vertical direction in order give them the appearance of a slot. In this example, the ports are identical to one another and are located at the same height by being regularly or irregularly spaced around the axis vertical of symmetry of the diffuser. They are arranged in a lower wall 81 of the head 79 which has a symmetry of revolution around the axis of the diffuser and of which the diameter decreases when moving from the head downwards. This lower wall 81 of the head is therefore oriented downwards and has for example the shape of a portion of a sphere. The atomization ports 80 are therefore oriented downwards and in the direction of the shelving 74 and the products 71.

The atomization ports 80 extend for example between 0.2 and 1 meter, more preferably 0.5 meter, over the shelving and over the highest portion of the bottom wall 75. In this example, the two first diffusers 77 are separated from one another by a distance of one meter and each extend to 0.5 meters from the edge of the display case. It is advantageous that the ports 80 are located at a height of approximately 0.3 m from the top of the products to be moistened which is about 0.5 m from the bottom of the shelving, but this depends on the height of the products. It is advantageous in this respect that the first diffusers 77 be adjustable in height.

The second diffusers 18 here are of a number of six and are located on the upper planar horizontal face 85 of the band 82 that forms the periphery of the display case by surrounding on all of its sides the bottom wall 75. The second diffusers extend protruding from this face 85 upwards. Three of the diffusers 18 extend over one of the end bands located on the left in FIG. 10 and the three others extend over the other end band located on the right in the same figure. On each band 82, the second diffusers are regularly spaced between each other and extend at a distance from two ends of the band.

The second diffusers 18, shown as having three, are located on the left and are aligned with one another, as well as the three second diffusers 18 located on the right. Each one of the corresponding straight lines is parallel to the straight line defined by the first diffusers 77. And the latter are between the two straight lines formed by the second diffusers. In addition, the second diffusers 18 form a set which surrounds all of the first diffusers 77.

As shown in FIGS. 12 and 13, the second diffusers 18 are identical to one another. They each include a head of hemispherical shape forming the upper portion of the diffuser which extends downwards starting from its equator via a cylindrical wall until it reaches the face 85. The wall of the head is therefore entirely oriented upwards. Each second diffuser 18 has an atomization port 83, here unique, of circular shape and arranged in the upper hemispherical wall of the diffuser in such a way that the axis of the atomization port is oriented upwards and more precisely here with an inclination of 45° with respect to the vertical direction. In addition, the port is directed in the direction of the plane P.

The atomization ports 83 of the second diffusers 18 therefore extend lower than those 80 of the first diffusers 77. They extend closer to the wall 75 and products than the first diffusers. Here, the second adjacent diffusers are spaced 0.666 meter and the diffusers located at the end of the row are spaced at the end of the closest band by 0.335 meter. The atomization ports 83 have for example a diameter of 8 mm.

As shown in FIG. 14, in an alternative embodiment, it is only the hemispherical portion of each second diffuser 18 that emerges from the band 82. In addition, the diffuser this time has two circular atomization ports 83, identical to one another and extending at the same height by being both oriented in the direction of the plane P. In another alternative not shown in the figures, again only the hemispherical portion of the second diffuser emerges from the band but the diffuser this time comprises a single port.

The mist generator, its electrical supply box and the fan are not shown for the embodiment according to FIGS. 8 to 14.

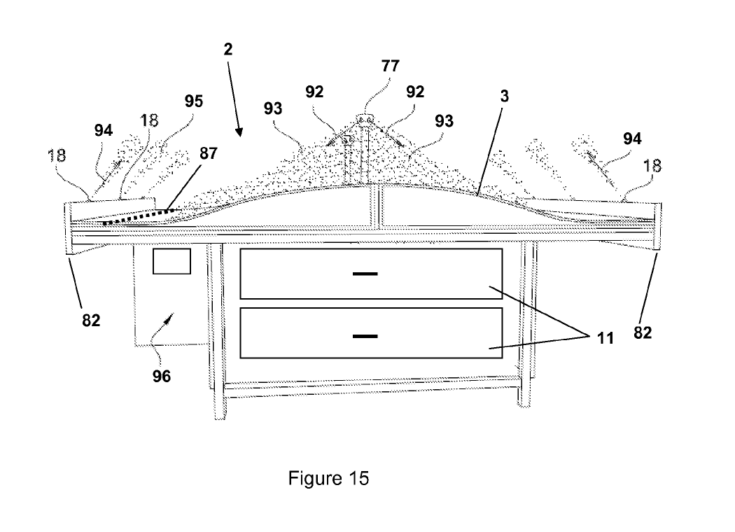

The suction is carried out through suction ports 87 (which can be seen in FIGS. 9, 10 and 15) in the caisson located in the frame 73. A higher number of suction ports and/or suction slots, for example close to the bands 82, can be provided. A grille in the surface 3 of the area for receiving 2 can also be arranged. The frame 73 or caisson can be arranged as an area for storing products, which can be accessed by one or several doors and/or possible provided with one or several sliding plates 11 (shown in FIG. 15). FIG. 15 more especially shows the principle of conflicting diffusion of mist by the first 77 and second 18 diffusers. In this example, the direction 94 of the mist 95 coming from the second diffusers 18 is directed towards the center of the area 2 for receiving products, while the direction 92 of the mist 93 coming from the first diffusers 77 is directed towards the periphery. The mist that tends to overflow from the low area of the surface 3 of the area 2 for receiving is sucked by the suction ports 87 arranged here parallel to the side bands 82.

In all of the embodiments, and in particular those shown in FIGS. 1 to 7, 8 to 15, 16, and 17, the facility comprises at least one droplet generator 14, supplied with water by a suitable means, and a system of ducts (not shown in the figures) by means of which the mist, produced by the generator or generators, is transmitted to the diffusers 18, 77. The supplying with mist of the second diffusers 18 is typically provided by ducts hidden in the bands 82 and themselves connected to the mist generator, and supplied with current by an electrical supply box (not shown in the figures). It is advantageous to connect each diffuser to a siphon, to which access is possible by dismounting the diffuser, in order to allow for the cleaning of the siphon and also in order to be able to extract from the siphon objects that may have been introduced in the ports of the diffusers by members of the public.

Generally (regardless of the embodiment), the facility according to the invention is controlled by means of a control box 96 (shown only in FIG. 15) making it possible to control and to adjust its operation. The box comprises in particular means for adjusting the three main operating parameters which are the quantity (density) of mist generated, the speed of the blowing fan for the mist, the speed of the suction fan; where applicable, it makes it possible to adjust other parameters such as the operating cycles or the safety thresholds. This box is advantageously arranged outside of the caisson; in an alternative, it can contain the droplet generator.

FIG. 15 shows the operation of the first and second diffusers for a table similar to that of FIG. 9: all of the diffusers simultaneously diffuse streams of mist via their atomization ports, over the wall 75 and the products 71. The first diffusers 77 diffuse streams of mist via their respective ports 80. In light of the regular distribution of the atomization ports all around each diffuser in this example, the mist is produced all around the diffuser by being directed as soon as it exits the port 80 downwards in the direction of the wall 75 and products 71 when they are present. The stream of mist exiting from each port has for example an inclination of approximately 30° with respect to the vertical direction.

Those of the ports 80 of the first diffusers 77 which are oriented in the direction of the end edges of the shelving diffuse the mist in the direction of a rectangular area 84a of the wall 75 which is delimited on the one hand by the plane P and on the other hand by the band 72 that carries the second diffusers 18 located on the left. This area therefore extends between the first diffusers 77 and thee three second diffusers 18.

The same applies, symmetrically, on the other side of the piece of furniture, over an area 84b located on the other side of the plane P, as shown in FIG. 10. The diffusers 77 as such extend between the two areas 84b and 84a and each supply the two areas simultaneously with mist. In the second diffusers 18, the stream of mist is oriented upwards and inclined at 45° with respect to the vertical direction. The streams produced by the three diffusers of each band cooperate in order to form a patch of parallel streams. The mist diffused as such rises first over the wall 75 and over the streams of mist produced by the first diffusers that is covers at least partially. The mist of the second diffusers, then, falls back in the direction of the areas 84b and 84a until it too reaches the products.

As such, the streams of the first diffusers directly refresh the products while the streams of the second diffusers rise first in the air before falling back on the products. Above all, they protect the mist emitted by the first diffusers with regards to the movements and currents of the ambient air in order to confine it and improve the homogeneity of the refreshing of the products.

According to the invention, the suction ports 15, 87 (which can be seen in FIGS. 1 to 3, 6, 7, 9, 10, and 15) suck at least a portion of the mist; this prevents it from overflowing over the end edges 76, in order to confine the patch of mist and in order to improve the covering of the products by the mist. Advantageously, the suction ports 87 are located especially in the lower portion of the wall 75, if the latter is inclined, as is the case in FIG. 15.

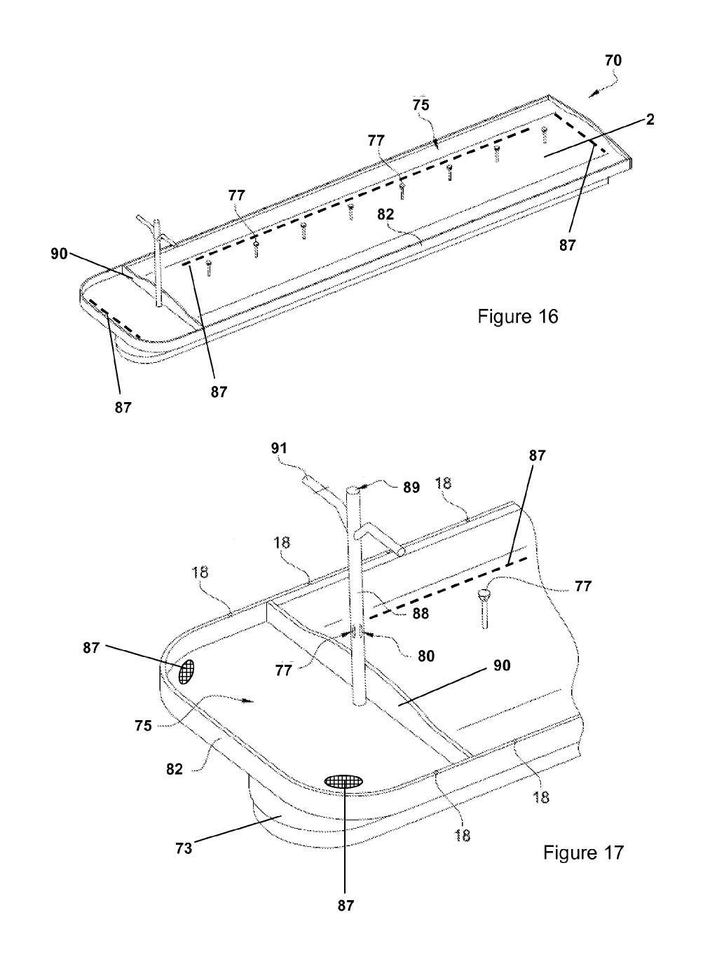

FIGS. 16 and 17 show an alternative embodiment of the piece of furniture 72 according to the invention.

As shown in FIG. 16, the piece of furniture has an elongated form; it can comprise a rounded shelf head (see FIG. 16) on at least one of its ends. The piece of furniture comprises first diffusers 77, arranged in the plane P and two groups of second diffusers 18 arranged on the bands 82 of respective ends (not shown in FIG. 16, but which can be seen in FIG. 17). Note a plurality of suction ports 87, arranged here as slots or as opening with a larger diameter but protected by grilles and arranged especially at the periphery of the area for receiving products 2. The frame 73 can be arranged in the form of a storage area, which can be accessed by a door (not shown in the figures).

FIG. 17 shows, as an alternative, a particular embodiment of one of the first diffusers 77 which is integrated into a mast 88 of a stem 89. The diffuser itself is carried out in the median portion of the mast with atomization ports 80 in the shape of a slot as previously. The stem 89 comprises in the upper portion a horizontal section 91 which can be used to hook various elements such as labels.

Generally, the diffusers 18, 77, and even said second diffusers 18, can have a height that varies according to the geometry of the facility and of the area 2 for receiving products. In particular, the second diffusers can be arranged directly on the band 12, as in the embodiment shown in FIGS. 1 to 7, 8 to 15 and 17, but they could also be arranged at a greater height, using a mast 78 as in FIG. 11.

Generally, the invention makes it possible to aesthetically and relatively discreetly integrate the function of atomization within a piece of furniture such as a display case. It can be provided that certain at least of the first and/or of the second diffusers be provided with a partial or total shutter member. This is the case for example with the second diffuser shown in FIGS. 12 and 13 which comprises an internal shutter that can be maneuvered from the outside of the diffuser by means of a mobile button 86 in a groove arranged in the wall of the diffuser. The cover and the button are mobile with a single part in rotation in relation to the external wall of the diffuser around a vertical axis, in order to make it possible to open or to close the diffuser as desired. When the first or the second diffuser comprises several ports and such a shutter, at least one of the ports can be closed off while leaving open at least one other port. These functions of partial and total closing off make it possible to select the diffusers and the ports that are active as well as the areas that must receive mist or to adjust the quantity of mist to be received by such and such area.

Such a piece of furniture makes it possible for example to diffuse mist on a surface of about 5 square meters by providing for example a total flow rate of atomized water of 0.5 kg/m2/hour. Generally, the facility according to the invention improves the effectiveness of the mist without needing to increase its density or its speed: the mist envelops the products better and is used better.

Many alternatives have been considered.

It can be provided to control the flow rate of each diffuser individually but it is often sufficient and more economical to define groups of diffusers of which the flow rate is jointly controlled. It is in this way that, in the example of FIG. 9, the flow rate of the first diffuser 77 located in the upper portion and the three diffusers 18 located on the left can be jointly controlled. These four diffusers mainly supply a surface of diffusion indicated as S1 in FIG. 9. Likewise, the flow rate of the other diffusers can be controlled jointly, namely the first diffuser 77 located in the lower portion and the three second diffusers 18 located on the right that supply mainly the surface S2. The surfaces S1 and S2 are identical and have nested “L” shapes. The operator in charge of the atomization can therefore choose to control the power of the atomization on the surface S1, the atomization power on the surface S2, the operating cycle for these two areas, or the ventilation speed.

It can be provided that the diffusers 77 comprise a mast allowing for the adjusting of the position of the head in height with respect to the surface 75. It can be provided that certain at least of the diffusers be integrated to horizontal tubes.

On each of the first and second diffusers, the number of ports can be modified, with this number able to equal to 1 or greater than or equal to 2. Likewise, the dimensions, the positions and the shapes given for each of the diffusers are not limiting. As such, the ports of the first diffusers can have a shape other than an elongated shape according to the vertical direction, for example a circular shape. The ports of the second diffusers can have a shape other than a circular shape, for example an elongated shape according to the vertical direction. If the head of one of the diffusers is mobile and motorized, it can be provided that it have a single port in a single direction, or encore several ports of different dimensions and oriented in different directions in order to optimize the distribution of the mist.

It can be provided that the piece of furniture comprises a single first diffuser and/or a single second diffuser. The number of first diffusers can be greater than 2. The number of second diffusers can be equal to 2 or greater than 3. It can be provided that the or each second diffuser have a height greater than or equal to that of the or of each first diffuser.

It can be provided that the or each first diffuser extends at the periphery of the display case, with the or each second diffuser extending for example at a distance from this periphery to the extent that the piece of furniture has a configuration that is inverted in comparison with that of FIG. 8. It can be provided that all of the diffusers extend at the periphery of the display case. The second diffuser can be located outside of the band of the display case, and for example in the vicinity of the latter when it is present.

It can be provided that the wall 75 be generally inclined with respect to the vertical direction, for example by being planar. In such a case, certain at least of the second diffusers are not oriented upwards but rather to the horizontal, and even downwards, while still remaining in the direction opposite the area supporting the products.

It is possible, and this is preferred, to configure the piece of furniture in such a way that, over the entire piece of furniture, the first diffusers provide a mist flow rate that is higher than the second diffusers. It can even be provided that the total flow rate of the piece of furniture be provided for three-quarters by the first diffusers, with the second diffusers providing the remaining quarter of this flow rate. It is also preferable that the stream of mist exits from the second diffusers with a higher speed than the stream of the first diffusers in order to suitably provide the confinement of the mist emitted by the first diffusers.

Of course, many other modifications can be made to the invention without leaving the scope of the latter. Moreover, the invention can be carried out with many alternatives, and the technical characteristics of the various embodiments described can be combined. A few general alternatives are mentioned here; they can also be combined together.

In a first alternative, the droplet generator 14 is located outside of the caisson 5, for example under the caisson, and not inside the caisson. This makes it possible to further improve the operation of the caisson, as the droplet generator 14 also generates heat which heats the air of the caisson 5. The droplet generator 14 can be arranged upstream or downstream of the fan 13.

In a second alternative, a portion of the mist sucked in the caisson 5 is sucked by the droplet generator 14 which must be supplied with air in order to generate a mist of water droplets.

In another alternative, it can be provided that each of the diffusers be mounted mobile in such a way as to be able to be oriented in relation to piece of furniture in order to choose the direction of diffusion of the mist.

Means of motorization can also be provided that make it possible to modify the orientation of the diffuser during the diffusion of the mist and without the intervention of an operator on the diffuser.

In another alternative, the floor 10 of the caisson 5 is slightly inclined in order to allow for a flow of the water from condensation that can form towards a tank or a drain, knowing that in optimum operation, there will not be any condensation, not on the products on the shelving or on the products in the caisson 5, or on the internal walls of the caisson 5.

In yet another alternative, the walls 6, 7, 8, 9 of the caisson 5 as well as its floor 10 are provided with thermal insulation.

The facility 1 can comprise one or several drawers 11. The latter can have punched bottoms (for example grilles) so that the mist passes through them and accesses the lower level.

In yet another alternative, which can be combined with all of the other alternatives described here, a ventilation fan 60, optional, can be provided which can be seen in FIGS. 5 and 6, which is arranged under the area 2 for receiving in the caisson 5; it can advantageously be arranged at about 45° with respect to the horizontal. It ventilates the air contained in the caisson 5 in order to provide a good distribution of the mist that enters the storage area of the caisson 5; this improves the contact of the mist with the products arranged in said product storage area located in the caisson 5. Said ventilation fan 60 also contributes to forcing the evaporation of the mist, which refreshes the caisson 5.

In another alternative, which can be combined with all of the other alternatives, it is provided that the surface 3 of the area 2 for receiving products can be formed by the bottom of standardized crates or baskets (made of wood, plastic or metal) which are inserted on a frame arranged over the caisson; the suction is carried out in this case through grilles, opening, slots or ports of said crates or baskets.

In yet another alternative, the suction ports have a distribution and/or dimensions such that different suction areas are created on the surface 3 of the area 2 for receiving products. The facility 1 can also have several areas 2 for receiving products which can be distinguished by their height, inclination, shape, characteristics of atomization and/or of suction.

The product storage area in the caisson is optional; by way of example, the facility 1 can also be carried out with a caisson of very low height and even without a caisson, in such a way as to be able to be placed on a table.

A filter can be provided making it possible to purify the mist that has been sucked, with this filter able to be arranged upstream or downstream of the fan 13 through which the mist can leave the caisson, and/or before its entry into the droplet generator.

With regards to the technical performance of a facility 1 according to the invention, the inventors have observed that it is capable of refreshing fruits in a typical store environment by at least 5° C., and more preferably by at least 6° C. in relation to an air temperature of the store between 23° C. and 25° C. at a relative humidity between 35% and 60%. Indeed, in these conditions, the method according to the invention makes it possible to obtain a temperature less than 20° C., more preferably less than 19° C. and still further preferentially less than 18° C. (with the dew point being about 17.2° C.), keeping in mind that these temperature measurements are taken on products at height of about 10 cm above the surface of the area for receiving 2 products.

Indeed, the droplets of water that are deposited on the surface of the products (fruits, vegetables, meat, fish, cheese etc.) using the mist evaporate and as such cool the products. As such, the facility 1 according to the invention prevents the loss on mass of these products via drying (which is, in the case of bananas, of about 1% per day of storage). Moreover, the facility 1 according to the invention makes it possible to store products in cold and as such prevent them from being heated caused by any internal chemical reactions (for example the exothermal transformation of fructose in lactose in the bananas).

By way of example, using a device according to FIGS. 1 to 6, it was possible to cool bananas displayed on the shelving and stored in the caisson down to a temperature less than 18° C. for an outside temperature of 24° C. and 50% relative humidity. The same performance was achieved for bananas stored on the storage area of the caisson.

Similar results were obtained for other fresh products.

1-15. (canceled)

16. A facility to present perishable products for sale, the facility comprising:
at least one area to receive the perishable products;
a generator to produce mist droplets;
at least one diffuser to spray the mist droplets over said at least one area to thereby refresh, moisten and/or cool said perishable products;
at least one suction port arranged in the surface of said at least one area; and
at least one suction mechanism to suck at least a portion of the mist droplets sprayed over said at least one area through said at least one suction port.

17. The facility of claim 16, wherein said generator is to produce mist droplets having an average droplet size between 1 μm and 4 μm.

18. The facility of claim 16, wherein said generator comprises a concentration nozzle.

19. The facility of claim 16, wherein said generator comprises a micro-perforated membrane.

20. The facility of claim 16, wherein the at least one diffuser is arranged at a periphery of said at least one area.

21. The facility of claim 16, wherein the at least one diffusers is to direct the mist droplets in a direction opposite said at least one area.

22. The facility of claim 16, further comprising a caisson to which is mounted said at least one area, and in communication with said at least one suction port.

23. The facility of claim 22, wherein the caisson is to be underpressurized by said suction mechanism such that during operation of the facility, said mist droplets are sucked into said caisson through said at least one suction port.

24. The facility of claim 22, wherein said caisson comprises an area for storing the perishable products, including at least one sliding drawer to receive the perishable products.

25. The facility of claim 24, further comprising at least one second diffuser arranged at said area for storing products.

26. The facility of claim 22, further comprising a ventilation fan arranged at said caisson.

27. The facility of claim 16, further comprising a band upon which is arranged the at least one diffuser.

28. A facility to present perishable products for sale, the facility comprising:
at least one area to receive the perishable products;
a generator to produce mist droplets;
at least one first diffuser to spray the mist droplets over said at least one area to thereby refresh, moisten and/or cool said perishable products;
at least one second diffuser to direct the mist droplets in a direction opposite the at least one area;
at least one suction port arranged in the surface of said at least one area; and
at least one suction mechanism to suck at least a portion of the mist droplets sprayed over said at least one area through said at least one suction port,
wherein said at least one area extends between said at least one first diffuser and said at least one second diffuser.

29. The facility of claim 28, wherein said at least one first diffuser and said at least one second diffuser are arranged in staggered fashion.

30. The facility of claim 28, further comprising a caisson to which is mounted said at least one area, and in communication with said at least one suction port.

31. The facility of claim 30, wherein the caisson is to be underpressurized by said suction mechanism such that during operation of the facility, said mist droplets are sucked into said caisson through said at least one suction port.

32. The facility of claim 30, wherein said caisson comprises an area for storing the perishable products, including at least one sliding drawer to receive the perishable products.

33. The facility of claim 32, further comprising:
at least one third diffuser arranged at said area for storing products; and
a ventilation fan arranged at said caisson.

34. A method four refreshing, moistening and/or cooling perishable products presented for sale, the method comprising:
providing a facility having at least one area to receive the perishable products, a generator to produce mist droplets, at least one diffuser to spray the mist droplets, at least one suction port arranged in the surface of said at least one area, and at least one suction mechanism;
diffusing, via said at least one diffuser, the mist of droplets over the perishable products; and then
suctioning, via said at least one suction mechanism, said mist of droplets through said at least one suction port arranged adjacent said surface.

35. The method of claim 34, wherein, for an ambient temperature between 23° C. and 25° C., and a relative ambient humidity between 35% and 60%, said diffusing comprises obtaining a temperature of at least 6° C. less than the ambient temperature, measured on the perishable products at a height of about 10 cm over the surface of the at least one area.
